(19) United States
(12) Patent Application Publication
(10) Pub. No.: US 2003/0184786 A1
(43) Pub. Date: Oct. 2, 2003

(54) Device and method for printing images from a video

(76) Inventors: Giovanni Venturi, Genova (IT); Francesco Diano, Vado Ligure (IT); Giovanni Ciardiello, Ivrea (IT); Paolo Gallina, Torino (IT)

Correspondence Address: BANNER & WITCOFF, 1001 G STREET N W, SUITE 1100, WASHINGTON, DC, 20001, US

(21) Appl. No.: 10/296,623

(22) PCT Filed: May 23, 2001
(86) PCT No.: PCT/IT01/00260

(51) Int. Cl. G06F 15/00; B41B 1/00

(52) U.S. Cl. 358/1.13; 358/1.18; 358/1.15

(57) ABSTRACT

A device generates images (50) which are displayed on a monitor (44) and transmitted to a printer (41); the images (50) are printed on a physical medium (46), in horizontal strips (51), in such a way that the time to print each band (51) overlaps with the time to acquire new images (50).

### TECHNICAL FIELD

The invention relates to a device for printing electronically generated black or colour images on a physical medium. The images may be generated by a video camera, or by equipment for producing scientific images, topographical images or images for medical diagnosis, by a telecommunications network, by a personal computer, by a machine for reproducing photographs, and the like. The same images are also displayed on a monitor and subsequently printed by means of, for instance, an ink jet printer.

### BACKGROUND ART

FIG. 1 depicts an ink jet printer 41 comprising a scanning carriage 42 having one or more monochromatic or colour printheads 40 on board. Printing is performed on a physical medium 46, normally consisting of a sheet of paper, a sheet of plastic, a fabric or the like. In particular, the paper may be of a type specially treated for the printing of photographs: for simplicity's sake, this will be referred to in the following as “special paper”. Also shown in FIG. 1 are the reference axes:

X axis: horizontal, i.e. parallel to the scanning direction of the carriage 42 with the heads 40; y axis: vertical, i.e. parallel to the direction of motion of the medium 46 during printing and the line feed function; z axis: perpendicular to the x and y axes, i.e. substantially parallel to the direction of emission of the droplets of ink.

The composition and general mode of operation of a printhead according to the ink jet technology are already widely known in the sector art, and will not therefore be discussed in detail herein, this description instead dwelling more fully on only those features of relevance for the purposes of understanding this invention. In FIG. 2 equipment is shown consisting of an image generator 43 suitable for generating images in analog video format, which comprises a monitor 44, and consisting also of a converter 70 suitable for converting the analog video signal into a digital signal, of a device 71 suitable for processing images in digital form, with the object of rendering the images suitable for printing, of a memory 72 suitable for storing one or more processed images, and of a printer 41 connected to the memory 72. The devices 70, 71 and 72 may constitute self-standing apparatus, as indicated in FIG. 2, or one or more thereof may be incorporated in the image generator 43 or in the printer 41.

Systems are known that are configured to produce a single image on a page of the support 46, these however have the drawback of wasting a lot of paper, which is extremely expensive if it is special paper.

Also known are systems which reproduce the successive images on a continuous strip, which is then cut into lengths, containing one or more images, which are left loose, or are joined using paper clips or the like, but which do not however constitute an effective archiving means.

Conversely, it is more convenient to print numerous images on a single page, as is illustrated for instance in FIGS. 3 and 4, in which single images 50 grouped on strips 51 can be seen.

In general, if we indicate with M the number of images per strip, with N the number of strips per page and with B the number of images per page, the following relation may be established:

B=M·N

In the example in FIG. 3, M=1 and N=3, so that B=3, whereas in the example in FIG. 4, M=2 and N=3, so that B=6.

In the patent U.S. Pat. No. 5,109,281 “Video printer with separately stored digital signals printed in separate areas to form a print of multiple images”, a way of printing a plurality of images on a single page is revealed.

If this process is adopted, for example, for printing multiple images produced by scanning or x-ray equipment, the electronic images are acquired and observed one at a time and only after an entire page has been printed, as indicated in the timing diagram of FIG. 5, which includes steps 100 of production and observation of the images on the monitor 44, a step 101 consisting of the set of all the steps 100 of production and observation of the images, a step 102 of printing a strip of images and a step 103 comprising the set of all the steps 102 of printing the strips. The following are also defined:

| tb | time of the step 100; |
|---|---|
| ta = B · tb | time of the step 101; |
| tn | time of the step 102; |
| ts = N · tn | time of the step 103; |
| T | time to produce an entire page. |
| The following is obtained: | |
| 1) | T = ta + ts = B · tb + N · tn |

Where the department in which the activity is being carried out is very costly and submitted to constant pressure by its users, as is normally the case in a medical diagnosis ward, it is desirable to reduce down times to a minimum, and to this end this invention reveals a device and a method for printing images which reduce the time T, by overlapping a good part of the printing time ts with the acquisition time ta.

### DISCLOSURE OF INVENTION

The object of the present invention is to print multiple images on a single sheet.

Another object is to reduce the time T needed to produce an entire sheet containing a plurality of B images.

A further object is to avoid printing on a continuous strip, in order to avoid the production of lengths containing one or more images.

Yet another object is to reduce printing time.

The above objects are attained by means of a device and method for printing images from video, characterized as defined in the main claims.

These and other objects, characteristics and advantages of the invention will become clear from the description that follows of a preferred embodiment, provided by way of a non-restricting example, and with reference to the accompanying drawings.

### BRIEF DESCRIPTION OF DRAWINGS

FIG. 1—Represents an axonometric view of an ink jet printer;

FIG. 2—represents an image generator connected to an ink jet printer through image processing and storing devices;

FIG. 3—represents a page containing a plurality of images;

FIG. 4—represents a page containing a second plurality of images;

FIG. 5—represents a timing diagram for the printing of a page containing a plurality of images, according to the known art;

FIG. 6—represents a page on which a strip of images has been printed, according to the invention;

FIG. 7—represents a page on which numerous strips of images have been printed, according to this invention;

FIG. 8—represents a timing diagram of the printing of a page containing a plurality of images, according to this invention.

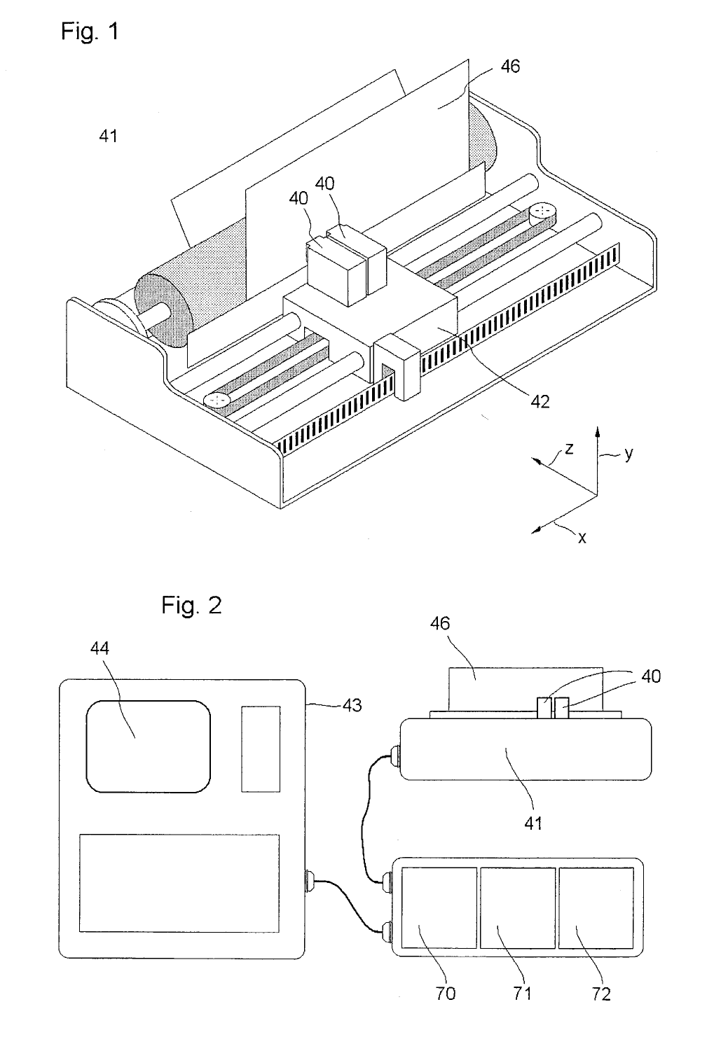

### BEST MODE FOR CARRYING OUT THE INVENTION

In a preferred embodiment, and with reference to FIG. 2, an image generator 43 is taken, consisting for instance of scanning equipment, which produces images, converts them into analog video signals using known techniques and sends them to the monitor 44, which makes them visible in order to permit a medical investigation, where the ultimate objective may be diagnosis. When an image is retained to be of interest, it is processed and sent to a printer 41 which reproduces it on a physical medium 46, usually though not exclusively consisting of special paper. The analog video signals are converted into digital signals by the converter 70, which are processed by the image processing device 71, and stored in the memory 72 using known techniques.

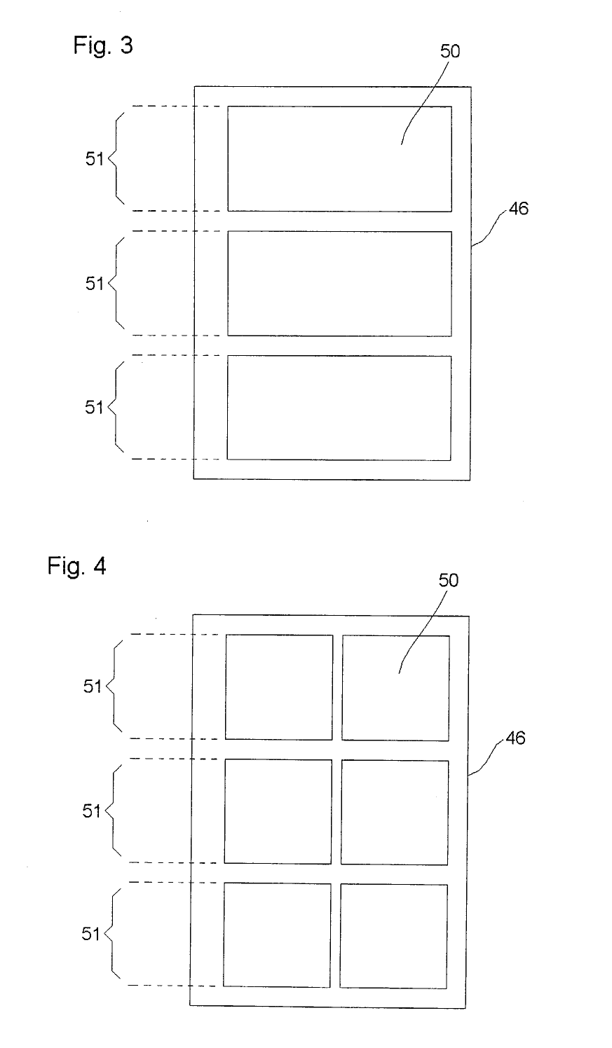

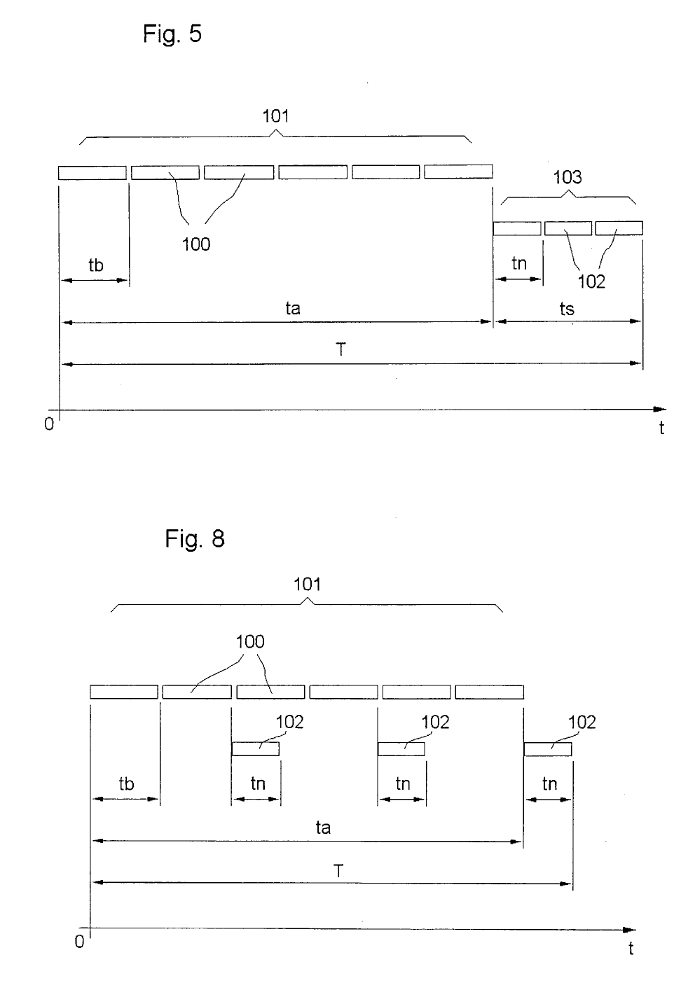

The images printed are generally not suitable for diagnosis, but are produced for the purpose of maintaining a set of documents that complete the patient's clinical file. To satisfy requirements of practicality and cost reduction, it is desirable to print numerous images on a single page of the physical medium 46, as in the example in FIG. 3, where three images 50 are printed on three strips 51, or of FIG. 4, where six images 50 are printed two by two on three strips 51.

To this end, the sequences of digital signals corresponding to the different images are sent successively to the memory 72 where they are stored, but the images are not printed immediately. In the known art, when a page is completed, or at the end of a diagnosis session if the page is not complete, a printout is commanded.

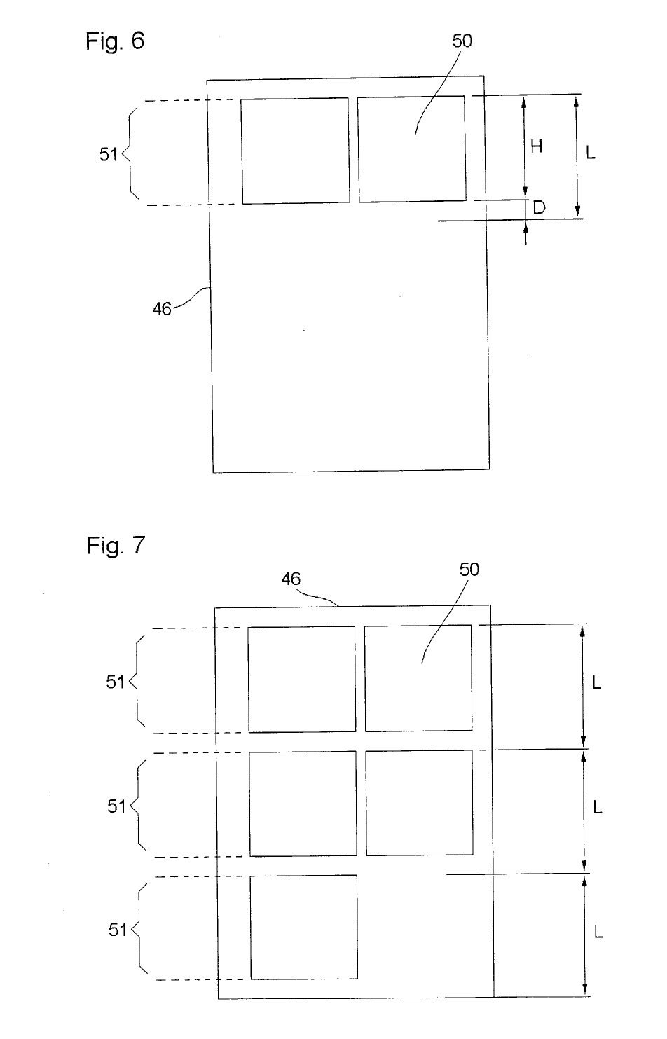

According to this invention, on the other hand, printing is activated as soon as a first strip 51 is completed, as illustrated in FIG. 6 where, for instance, the first strip contains two images 50. This allows the image generator 43 to immediately send the monitor 44 new images which are observed and evaluated by the operator while the previous images are being printed, without any loss of time.

The printing and other operations described below are carried out by means of a software or firmware program, or by means of a wired logic circuit, in turn made up of discrete or integrated components, not described because they are known to those acquainted with the sector art.

During the printing, the medium 46 is fed parallel to the y axis after each scan of the carriage 42. When printing of the first strip 51 is complete, the medium 46 will have been moved in total by an interval equal to the height H of an image 50, and is further moved parallel to the y axis by an interval equal to the distance D between two successive strips 51, so as to complete a feeding L=H+D, after which it is stopped in stand-by mode.

The feeding of the medium 46 comprises a motion relative to the heads 40, and thus the principle of this invention is still valid even when the medium 46 is held motionless with respect to the fixed structure of the printer 41, while the heads 40 are fed with a motion substantially parallel to the y axis.

When another two images have been sent to the memory 72 and stored, thus completing the preparation of a second strip 51, printing is activated again, and the medium 46 is again fed parallel to the y axis by a second feeding L, upon completion of which it is again stopped in stand-by awaiting a new strip, and so on until the page is completed. At this point, the medium 46 is expelled by means of techniques known to those acquainted with the sector art.

FIG. 7 illustrates a case in which it is assumed, for example, that the diagnosis session finishes with the production of a number of images 50 that is not a multiple of M, and that printing of the page therefore has to be performed when the last strip 51 is not complete: in this case, the operator activates printing of the incomplete strip by means of a manual print command. At this point, the page is terminated, and expulsion of the medium 46 is also activated.

Likewise, if the diagnosis session finishes with the production of a number of strips 51 less than N, the operator activates completion of the printing of an incomplete strip and expulsion of the medium 46 by means of a manual expulsion command, after which a new medium 46 is fed into the printer and fed to the right position for printing of a new first strip of images.

FIG. 8 presents a timing diagram for the production and printing of images according to the invention described, in which the following values are assumed, by way of example:

M=2; N=3; B=M·N=6

Two of the three steps 102 in the printing of a strip overlap with the step 101 of production and observation of the images on a monitor, and therefore the time T for production of an entire printed page is reduced according to the following relation:

T=ta+tn=B·tb+tn 2)

From comparison with the relation 1), a reduction of the total time is obtained equal to (N−1)·tn.

The invention may be produced with a different sequence of steps from that described and, in short, without prejudice to the principle of the invention itself, the construction details and the embodiments may be abundantly varied with respect to what has been described and illustrated, without departing from the scope of the invention.

1. Device for printing images comprising:
a converter (70) for receiving analog video signals representing images (50) and for converting said analog video signals into digital signals, said analog video signals being produced by an external image generator (43);
a memory (72) suitable for storing said digital signals; and
a printer (41) comprising means for receiving said digital signals and one or more printheads (40) provided with a scanning movement parallel to a first direction (x), said printer (41) being adapted for printing a plurality of said images (50) on a page of a physical medium (46) provided with a motion relative to said heads (40) substantially parallel to a second direction (y) substantially perpendicular to said first direction (x),
characterized in that it also comprises means for grouping said images (50) on said page of said physical medium (46) in a plurality of strips (51) substantially parallel to said first direction (x), and means suitable for commanding the printing of one of said strips (51) when all the images (50) belonging to said one of said strips (51) have been stored in said memory (72).

2. Device according to claim 1, characterized in that it also comprises means suitable for stopping said relative motion of said medium (46) with respect to said heads (40) on completion of the printing of each of said strips (51).

3. Device according to claim 1, characterized in that said printer (41) is operable by means of a manual print command, and that said printing of one of said strips (51) is activated when said manual expulsion command is actuated.

4. Device according to claim 1, characterized in that it further comprises means suitable for expelling said medium (46) when the printing of said page of said physical medium (46) is completed.

5. Device according to claim 4, characterized in that said printer (41) is operable by means of a manual expulsion command, and that said means suitable for expelling said medium (46) are activated when said manual expulsion command is actuated.

6. Device according to claim 1, characterized in that said image generator (43) produces images (50) suitable for medical investigation.

7. Device according to claim 6, characterized in that said images (50) are obtained through scanning.

8. Device according to claim 6, characterized in that said images (50) are obtained through X-rays.

9. Device according to claim 1, characterized in that said printer (41) is of the ink jet type.

10. Device according to claim 1, characterized in that said converter (70), said memory (72), or both belong to said printer (41).

11. Device according to claim 1, characterized in that said converter (70), said memory (72), or both are included in said external image generator (43).

12. Method for printing images (50) comprising the steps of:
receiving at the input of a converter (70) analog video signals representing images (50) from an external image generator (43);
converting said analog video signals into digital signals by means of said converter (70);
storing said digital signals corresponding to said images (50) in a memory (72); and
sending said digital signals to a printer (41) suitable for printing a plurality of said images (50) on a page of a physical medium (46), said printer (41) also comprising one or more printheads (40);
characterized in that it also comprises the steps of:
a) waiting for the reception and storage of a plurality of (M) of said images (50);
b) activating the printing of said plurality of (M) images (50) on said page of said physical medium (46), said images (50) forming a strip (51) substantially parallel to a first direction (x);
c) receiving, simultaneously with the step b), at the input of said converter (70), further analog video signals representing images (50) from said external image generator (43).

13. Method according to claim 12 characterized in that said printer is also suitable for receiving a manual print command, and that said step a) of waiting for the reception and storage of a plurality of (M) of said images (50) is substituted by a step:
d) waiting for activation of said manual print command.

14. Method according to claim 13 characterized in that said printing also comprises the activation of a relative motion of said medium (46) with respect to said heads (40) substantially parallel to a second direction (y) perpendicular to said first direction (x), and that said method also comprises the steps of:
e) maintaining said relative motion of said medium (46) with respect to said heads (40) until the completion of a distance between the strips (D);
f) stopping said relative motion of said medium (46) with respect to said heads (40);
g) returning to the step a).
